(19) United States
(12) Patent Application Publication
(10) Pub. No.: US 2019/0376578 A1
(43) Pub. Date: Dec. 12, 2019

(54) PLANETARY DAMPER WITH CLOCK SPRING

(71) Applicant: GM GLOBAL TECHNOLOGY OPERATIONS LLC, Detroit, MI (US)

(72) Inventors: Derek Lahr, Howell, MI (US); Farzad Samie, Franklin, MI (US); Dongxu Li, Troy, MI (US); Anthony Coppola, Rochester Hills, MI (US)

(21) Appl. No.: 16/002,909

(22) Filed: Jun. 7, 2018

(51) Int. Cl. F16F 15/121; F16F 15/12; F16D 3/12; F16H 45/02; F16F 15/123

(52) U.S. Cl. CPC F16F 15/1213; F16F 15/1206; F16D 3/12; F16H 45/02; F16F 2238/026; F16H 2045/0268; F16F 2224/0208; F16F 2224/0241; F16F 15/1232

(57) ABSTRACT

A planetary damper is disclosed that includes a planetary gear set and at least one clock spring. The planetary gear set includes multiple rotatable gear components including a sun gear, a planet gear assembly having a plurality of pinion gears rotatably mounted on a planet carrier, and a ring gear. The at least one clock spring includes an elongated substrate wound circumferentially around the planetary gear set. The clock spring has an innermost radial rung and an outermost radial rung spaced radially outwardly from the innermost radial rung. Each of the innermost radial rung and the outermost radial rung is connected to a different one of the gear components of the planetary gear set such that the clock spring damps vibrations imparted to the planetary damper. The use of the planetary damper within torque converter assembly to damp torsional vibrations is also disclosed.

### INTRODUCTION

Damping mechanisms are used in several locations throughout a vehicle to diminish the effects of unwanted vibrations. In an automatic transmission, for example, a torque converter is employed to transfer power from a crankshaft being driven by the engine to the input shaft of the transmission. The torque converter includes a pump and a turbine. The pump is secured to a housing of the torque converter, which, in turn, is joined to the engine crankshaft by way of a flex plate. The turbine is disposed adjacent to the pump within the torque converter housing and is mounted to the input shaft of the transmission. The pump and the turbine are fluidly coupled in that the rotation of the pump—the speed of which is determined by the engine—forces centrifugally displaced hydraulic fluid against opposed vanes of the turbine and thereby propels rotation of the turbine by way of a hydrodynamic circuit. When the pump and the turbine are rotating at or close to the same speed, a torque converter clutch (TCC) is typically engaged to break the hydrodynamic circuit and mechanically couple the engine crankshaft and the transmission input shaft together in an effort to improve fuel efficiency. By doing so, however, torsional vibrations from the engine can be readily transmitted to the transmission. Such vibrations can irritate the passengers in the vehicle.

A wide variety of dampers have been developed over the years to isolate the engine torsional from the transmission and, thus, the rest of the driveline. Prior torsional dampers have conventionally used coil springs in one form or another housed within a damper plate or other damping architecture incorporated into the TCC. These dampers are becoming less effective today as smaller high-torque, low-speed engines are generating more power and, as a result, the engine torsional for a given mean torque is increasing in amplitude as compared to older engines. Under these circumstances, the relatively stiff coil springs used in conventional torsional dampers—the springs, after all, need to be able to support torque transfer from the engine to the driveline—absorb and release more energy during compression/relaxation cycles. And because the coil springs are caged or otherwise supported, more than an inconsequential amount of that energy can be lost (i.e., hysteresis) as the springs drag across and/or otherwise experience dynamic contact with their adjacent supporting surfaces. The end result of this more pronounced hysteresis is a reduction in fuel economy.

The planetary damper disclosed herein utilizes an improved damping structure having at least one clock spring that minimizes hysteresis over a broad range of engine torsional vibrations. The planetary gear set of the damper includes a sun gear, a planet gear assembly, and a ring gear, and the at least one clock spring is connected to any two of those gear components. One of the gear components to which the clock spring is connected is the input or the output of the planetary damper while the other gear component to which the clock spring is connected is a free node, i.e., it is not the input or the output. This provides a mechanical advantage in that the effective spring rate of the clock spring experienced by the engine is less than the spring rate of the clock spring itself by a factor of (Ra+1)^{1/2} where “Ra” is the gear ratio between the different gear components associated with the input and the output of the planetary damper. The lower effective spring rate enables the planetary damper to better isolate vibrations from downstream componentry. Additionally, the at least one clock spring is self-supported circumferentially around the planetary gear set and, consequently, the hysteresis that typically accompanies the use of supported coil springs is avoided. The planetary damper is well-suited for use in an automatic transmission to dampen torsional vibrations from the engine whenever the TCC is engaged to mechanically couple the engine crankshaft to the transmission input shaft, although it may be used in other applications as well. Multiple variations of the planetary damper are possible.

### SUMMARY OF THE DISCLOSURE

A planetary damper according to one aspect of the present disclosure includes a planetary gear set and a least one clock spring. The planetary gear set has multiple rotatable gear components. The gear components comprise a sun gear, a planet gear assembly having a plurality of pinion gears rotatably mounted on a planet carrier, and a ring gear. Each of the plurality of pinion gears have external teeth that mesh with external teeth of the sun gear, and the ring gear has internal teeth that mesh with the external teeth of each of the plurality of pinion gears. The at least one clock spring comprises an elongated substrate wound circumferentially around the planetary gear set. The clock spring has an innermost radial rung and an outermost radial rung spaced radially outwardly from the innermost radial rung. The innermost radial rung of the clock spring is connected to one of the gear components of the planetary gear set and the outermost radial rung of the clock spring is connected to another of the gear components of the planetary gear set such that the clock spring damps vibrations when the gear components to which the clock spring is connected experience relative angular movement.

The planetary damper may include additional features or be further defined. For example, the elongated substrate of the clock spring may be composed of a metal or alloy, or it may include a fiber reinforced composite that comprises one or more fiber tows encapsulated by a resin matrix material. If comprised of one or more fiber tows encapsulated by a resin matrix material, each of the fiber tows may comprise a bundling of fibers comprising glass fibers, carbon fibers, natural fibers, polymer fibers, elastomeric fibers, metallic fibers, or shape memory alloy fibers, and additionally the resin matrix material may comprise a cured epoxy resin, a cured polyurethane resin, or nylon. Moreover, the fiber reinforced composite may comprise a plurality of fiber tows that includes at least multiple first fiber tows and multiple second fiber tows, with the first fiber tows and the second fiber tows being comprised of a different bundling of fibers. Still further, an inner channel may be defined within the fiber reinforced composite material of the elongated substrate. The inner channel may be a central inner channel that extends along a lengthwise extent of the elongated substrate and is surrounded circumferentially by the one or more fiber tows.

A torque converter assembly according to another aspect of the present disclosure includes a torque converter, a planetary damper, and a torque converter clutch. The torque converter includes a pump and a turbine enclosed within a torque converter housing. The pump is secured to a front cover of the torque converter housing, which is rotationally driven by an engine crankshaft, and the turbine is mounted on a transmission input shaft. The planetary damper is mounted on the transmission input shaft and includes a planetary gear set and at least one clock spring. The planetary gear set has multiple rotatable gear components. The gear components comprise a sun gear, a planet gear assembly having a plurality of pinion gears rotatably mounted on a planet carrier, and a ring gear. Each of the plurality of pinion gears has external teeth that mesh with external teeth of the sun gear, and the ring gear has internal teeth that mesh with the external teeth of each of the plurality of pinion gears. The at least one clock spring comprises an elongated substrate wound circumferentially around the planetary gear set. The clock spring has an innermost radial rung and an outermost radial rung spaced radially outwardly from the innermost radial rung. The innermost radial rung of the clock spring is connected to one of the gear components of the planetary gear set and the outermost radial rung of the clock spring being connected to another of the gear components of the planetary gear set. The torque converter clutch is engageable to couple the planetary damper to the front cover of the torque converter housing to transfer torque mechanically from the engine crankshaft to the transmission input shaft through the planetary damper. The planetary damper damps the transmission of torsional vibrations from the engine crankshaft to the input transmission shaft when the torque converter clutch is engaged. To that end, only one of the gear components to which the clock spring is attached is driven by the engine crankshaft or drives the transmission input shaft when the torque converter clutch is engaged.

The torque converter assembly may include additional features or be further defined. For instance, the innermost radial rung of the clock spring may be connected to the one of the ring gear or the planet gear assembly of the planetary gear set, and the outermost radial rung may be connected to the other of the ring gear or the planet gear assembly. In another example, the elongated substrate of the clock spring may include a fiber reinforced composite that comprises one or more fiber tows encapsulated by a resin matrix material. In one implementation, the fiber reinforced composite includes a plurality of fiber toes, each of which comprises a bundling of fibers. The plurality of fiber tows may further include at least multiple first fiber tows and multiple second fiber tows, with the first fiber tows and the second fiber tows being comprised of a different bundling of fibers. Moreover, the plurality of fiber tows may be circumferentially arranged about and surround a central inner channel defined within and extending along a lengthwise extent of the fiber reinforced composite.

As another example, the torque converter clutch included in the torque converter assembly may include a piston plate that that is engageable to press an intervening friction plate against the front cover of the torque converter housing. Additionally, the planetary damper may include a connection plate attached to the gear component to which the innermost radial rung of the clock spring is connected or to the gear component to which the outermost radial rung of the clock spring is connected. This connection plate may be further attached to the friction plate and be located on an opposite side of the piston plate from the friction plate.

A torque converter assembly according to another aspect of the present disclosure includes a torque converter, a planetary damper, and a torque converter clutch. The torque converter includes a pump and a turbine enclosed within a torque converter housing. The pump is secured to a front cover of the torque converter housing, which is rotationally driven by an engine crankshaft, and the turbine is mounted on a transmission input shaft. The planetary damper is mounted on the transmission input shaft and includes a planetary gear set having multiple rotatable gear components. The gear components comprise a sun gear, a planet gear assembly having a plurality of pinion gears rotatably mounted on a planet carrier, and a ring gear. Each of the plurality of pinion gears has external teeth that mesh with external teeth of the sun gear, and the ring gear has internal teeth that mesh with the external teeth of each of the plurality of pinion gears. The at least one clock spring comprise an elongated substrate wound circumferentially around the planetary gear set. The clock spring has an innermost radial rung and an outermost radial rung spaced radially outwardly from the innermost radial rung. The innermost radial rung and the outermost radial rung of the clock spring are separately connected to any two the rotatable gear components of the planetary gear set. The torque converter clutch is engageable to couple the planetary damper to the front cover of the torque converter housing to transfer torque mechanically from the engine crankshaft to the transmission input shaft through the planetary damper. In so doing, one of the gear components to which the clock spring is attached is driven by the engine crankshaft via the torque converter housing or drives the transmission input shaft, and the other gear component to which the clock spring is attached is neither driven by the engine crankshaft nor drives the transmission input shaft, such that the planetary damper damps the transmission of torsional vibrations from the engine crankshaft to the input transmission shaft when the torque converter clutch is engaged.

The torque converter assembly may include additional features or be further defined. For example, the elongated substrate of the clock spring may include a fiber reinforced composite that comprises one or more fiber tows encapsulated by a resin matrix material. In one implementation, the fiber reinforced composite comprises a plurality of fiber tows. The plurality of fiber tows may be circumferentially arranged about and surround a central inner channel defined within and extending along a lengthwise extent of the fiber reinforced composite, and the central inner channel may be filled with a gas and/or a liquid. As another example, the torque converter clutch may include a piston plate that is engageable to press an intervening friction plate against the front cover of the torque converter housing, and the planetary damper may include a connection plate attached to the ring gear or the planet gear assembly and being located on an opposite side of the piston plate from the friction plate. The connection plate is further attached to the friction plate.

### BRIEF DESCRIPTION OF THE DRAWINGS

FIG. 1 is a perspective view of the planetary damper according to one embodiment of the present disclosure with the carrier separated from the rest of the damper;

FIG. 2 is a cross-sectional view of the planetary damper illustrated in FIG. 1;

FIG. 3 is a partial cross-sectional view of an automatic transmission that includes the planetary damper depicted in FIGS. 1-2 according to one embodiment of the present disclosure;

FIG. 4 is a partial cross-sectional view of an automatic transmission that includes an alternative configuration of the planetary damper depicted in FIGS. 1-2 according to one embodiment of the present disclosure;

FIG. 5 is a cross-sectional view of the clock-spring of the planetary damper, taken along section line 5-5, according to one embodiment of the present disclosure;

FIG. 6 is a cross-sectional view of the clock-spring of the planetary damper, taken from the same perspective as FIG. 5, according to another embodiment of the present disclosure;

FIG. 7 is a cross-sectional view of the clock-spring of the planetary damper, taken from the same perspective as FIG. 5, according to yet another embodiment of the present disclosure;

FIG. 8 is a schematic illustration of the orientation of the plurality of fiber tows of the reinforced composite material according to one embodiment of the present disclosure;

FIG. 9 is a schematic illustration of the orientation of the plurality of fiber tows of the reinforced composite material according to another embodiment of the present disclosure; and

FIG. 10 is a perspective view of multiple clock springs that may be included in the planetary damper according to various embodiments of the present disclosure.

### DETAILED DESCRIPTION

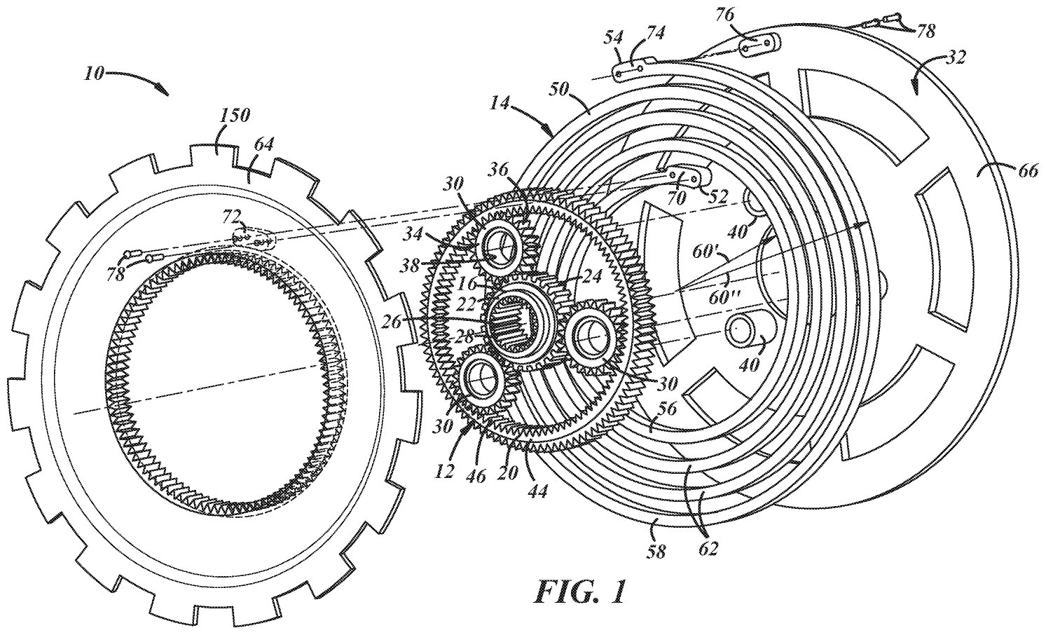

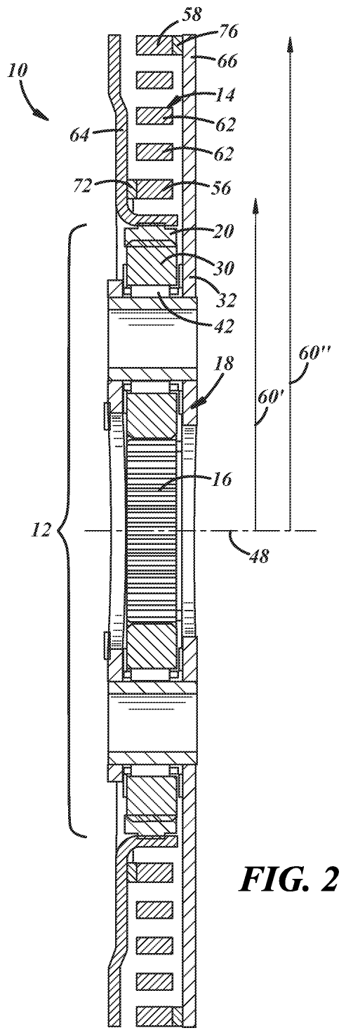

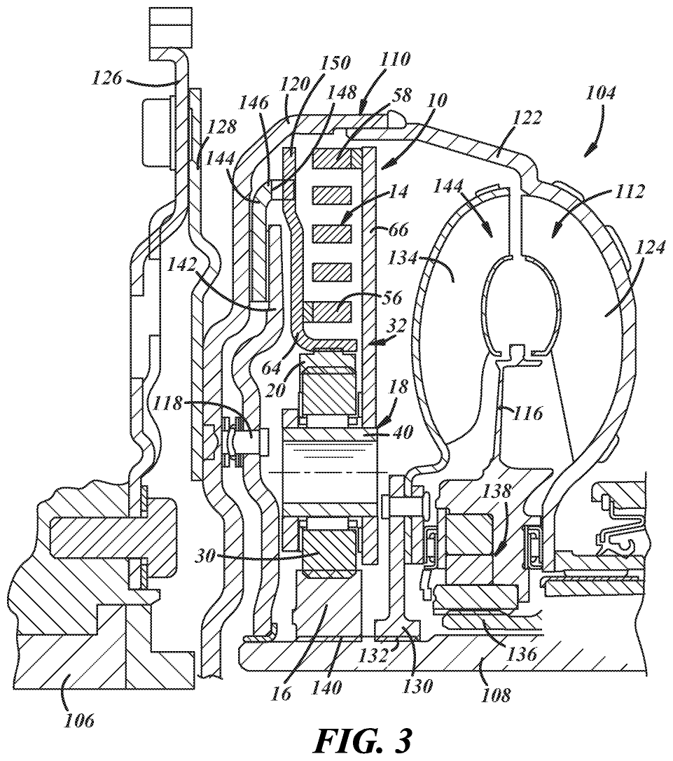

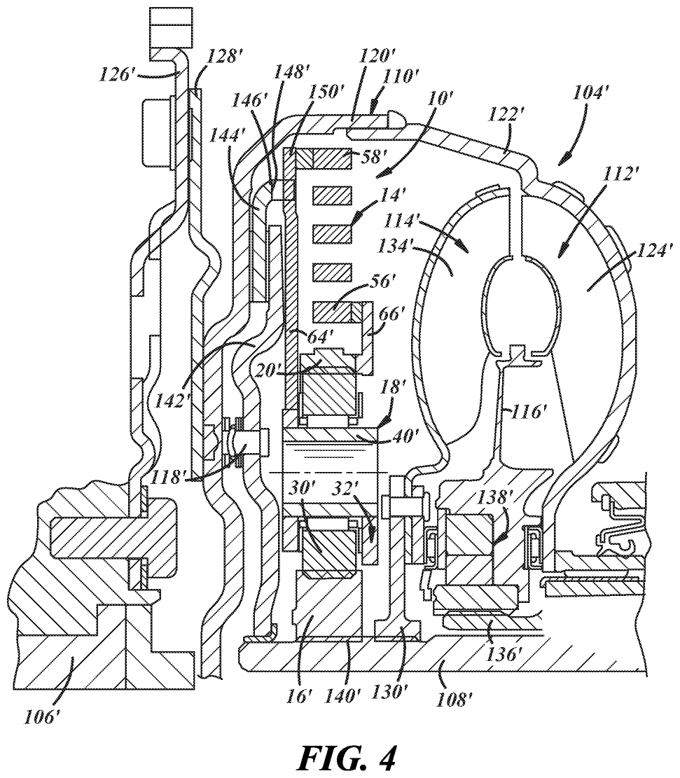

FIGS. 1-2 depict a planetary damper 10 according to one embodiment of the present disclosure. The planetary damper 10 includes a planetary gear set 12 and at least one self-supported clock spring 14 wound circumferentially and coaxially around the planetary gear set 12. The at least one clock spring 14 is connected to two different components of the planetary gear set 12 with one of those components serving as the input or the output of the planetary damper 10 and the other being neither the input nor the output but, instead, being a free node within the damper 10. The gear ratio (Ra) between the gear components that serve as the input and the output of the planetary damper 10, in turn, reduces the spring rate of the clock spring as experienced by the engine or other prime mover, essentially decreasing the effective spring rate of the clock spring, to enhance the absorption of vibrational energy. To that end, as part of a larger automatic transmission package, the planetary damper 10 is may be installed in a torque converter assembly along with a torque converter clutch to damp torsional vibrations emanating from an upstream engine whenever the torque converter clutch is engaged. Several examples using the planetary damper 10 in this fashion are described below in connection FIGS. 3-4. The planetary damper 10 may also be an attractive option for a variety of other non-automotive applications as the damper 10 is not necessarily limited solely to being used in a torque converter assembly as described below.

The planetary gear set 12 includes three rotatable gear components: a sun gear 16, a planet gear assembly 18, and a ring gear 20. The sun gear 16 has a body 22 that includes external gear teeth 24 as well as internal gear teeth 26 that are arranged circumferentially about a central opening 28 of the body 22, although the internal gear teeth 26 need not necessarily be present. The planet gear assembly 18 includes a plurality of pinion gears 30—typically three to six—mounted in a fixed spaced relation on a planet carrier 32. Each of the plurality of pinion gears 30 has a body 34 that includes external gear teeth 36 and defines a central opening 38. The planet carrier 32 may be a circumferentially slotted plate, as shown, that includes an interconnecting carrier member having a plurality of pinion shafts 40 that extend outwardly therefrom, or it may be some other structure that interconnects the pinion shafts 40. Each of the pinion gears 30 is individually rotatably mounted on one of the pinion shafts 40 of the planet carrier 32. For example, as shown here, each of the pinion gears 30 receives one of the pinion shafts 40 through its central opening 38 and is further supported on its respective pinion shaft 40 by an intervening needle bearing 42. The ring gear 22 has an annular body 44 that includes internal gear teeth 46.

The planetary gear set 12 has an axis of rotation 48 about which each of the gear components 16, 18, 20 can rotate. This axis of rotation passes through and is coincident with the axial centerline of the central opening 28 of the sun gear 16. When the planetary gear 12 set is assembled, the pinion gears 30 are circumferentially spaced around the sun gear 16 as determined by the spacing of the pinion shafts 40 on the planet carrier 32, and the external teeth 36 of the pinion gears 30 mesh with the external teeth 24 of the sun gear 16. Additionally, the ring gear 22 surrounds the pinion gears 30. The internal gear teeth 46 of the ring gear 22 mesh with the external gear teeth 36 of the pinion gears 30. In this way, the pinion gears 30 are located between and in meshed engagement with the sun gear 16 on their inside and the ring gear 20 on their outside. When the planetary damper 10 is in use, one of the gear components 16, 18, 20 is associated with an input or driving member, such as an engine crankshaft, and thus transfers torque into the planetary gear set 12, while another of the gear components 16, 18, 20 is associated with an output or driven member, such as an input transmission shaft, and thus transfers torque out of the planetary gear set 12. The third gear component 16, 18, 20 is free in that it is not directly driven nor does it directly drive any portion of the powertrain.

The clock spring 14 comprises an elongated substrate 50 that is wound circumferentially around the planetary gear set 12. The elongated substrate 50 is continuously wound around itself within a generally singular plane between an interior end 52 and an exterior end 54 and, consequently, provides the clock spring 14 with an innermost radial rung 56 and an outermost radial rung 58. The innermost radial rung 56 of the clock spring 14 is positioned closest to the planetary gear set 12 and defines an inner radius 60′ of the clock spring 14. The outermost radial rung 58, which overlaps and is radially outwardly spaced from the innermost radial rung 56, is positioned farthest from the planetary gear set 12 and defines an outer radius 60″ of the clock spring 14. Additionally, the clock spring 14 may include one or more intervening radial rungs 62 located between the innermost radial rung 56 and the outermost radial rung 58 depending on the number of times the elongated substrate 50 is wound about itself. Anywhere from one to ten intervening radial rungs 62 may be present. The interior end 52 and the exterior end 54 of the clock spring 14 are each be connected to the planetary gear set 12. More than one clock spring 14 may be included in the planetary damper 10 as will be further described below.

The clock spring 14 is connected to any two of the gear components 16, 18, 20 of the planetary gear set 12. The connections are preferably established at the innermost radial rung 56 and the outermost radial rung 58 of the clock spring 14. In that regard, the innermost radial rung 56 may be connected to one of the sun gear 16, the planet gear assembly 18, or the ring gear 20, and the outermost radial rung 58 may be connected to another of the sun gear 16, the planet gear assembly 18, or the ring gear 20. By connecting the innermost radial rung 56 and the outermost radial rung 58 to two different gear components 16, 18, 20 of the planetary gear set 12, the clock spring 14 can provide a damping functionality when (1) an input member (e.g., an engine crankshaft) drives one of the gear components to which the clock spring 14 is attached and the gear component to which the clock spring 14 is not attached drives an output member (e.g., an input transmission shaft), or when (2) one of the gear components to which the clock spring 14 is attached drives an output member and the gear component to which the clock spring 14 is not attached is driven by an input member. In a preferred embodiment, and as shown in FIGS. 1-2, the innermost radial rung 56 of the clock spring 14 is connected to the planet carrier assembly 18 or the ring gear 20, and the outermost radial rung 58 is connected to the other of the planet carrier assembly 18 or the ring gear 20. Any of a wide variety of techniques may be employed to connect the innermost radial rung 56 and the outermost radial rung 58 of the clock spring 14 to its selected gear component 16, 18, 20 of the planetary gear set 12.

Each of the innermost radial rung 56 and the outermost radial rung 58 of the clock spring 14 may be connected to its respective gear component 16, 18, 20 by a plate. As shown best in FIG. 2, a connection plate 64 may be splined to the ring gear 20, and a support plate 66 may integrally extend from or be separately affixed by welding and/or mechanically interlocking to the planet carrier 32. The innermost radial rung 56 of the clock spring 14 may include a planar connection end 70 that is affixed to a boss 72 of the connection plate 64. Similarly, the outermost radial rung 58 of the clock spring 14 may include a planar connection end 74 that is affixed to a boss 76 of the support plate 66. The inwardly extending bosses 72, 76 are included on the connection and support plates 64, 66 to facilitate connection with the planar connection ends 70, 74 without having to skew or twist the clock spring 14. The planar connection ends 70, 74 and their respective bosses 72, 76 may be affixed using fasteners 78, such as bolts or rivets, that extend through aligned openings defined in the connection ends 70, 74 and their respective bosses 72, 76. Other approaches may of course be used to affix the connection ends 70, 74 and their respective bosses 72, 76 including, for example, a weld joint or a braze joint.

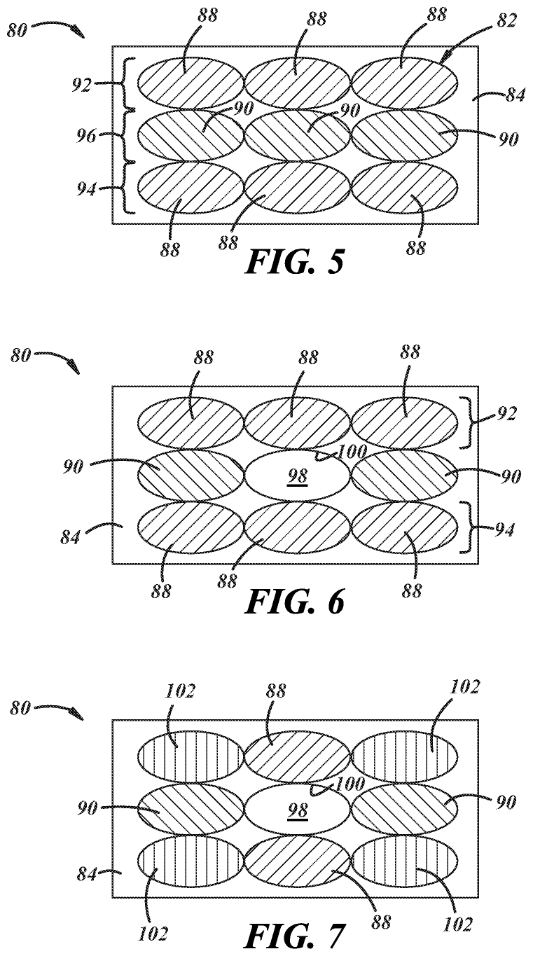

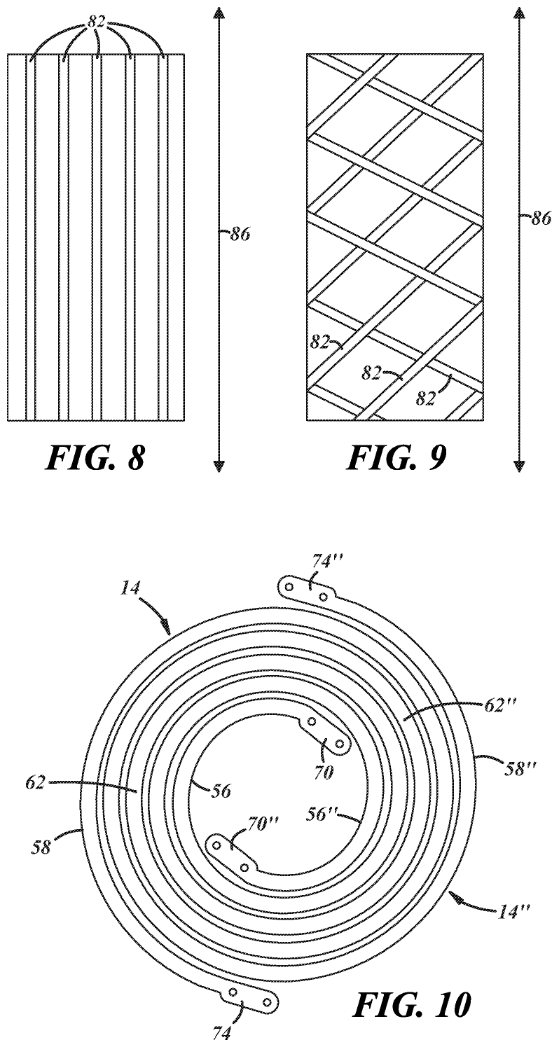

The construction of the elongated substrate 50 that is wound into the clock spring 14 may be varied to tailor the characteristics (e.g., mass, stiffness, etc.) of the clock spring 14 as needed for a particular application of the planetary damper 10. In one implementation, the elongated substrate 50 may be composed of a metal or alloy such as, for example, steel. In another implementation, and referring now to FIG. 5, the elongated substrate 50 may be a fiber reinforced composite material 80. The fiber reinforced composite material 80 includes one or more fiber tows 82 encapsulated by a resin matrix material 84. Each of the fiber tows 82 includes a larger number—often hundreds or even thousands—of individual fibers that are bundled together to give the tow 82 a cross-sectional area that typically, but not necessarily, ranges from 0.05 mm² to 100 mm². Anywhere from a single tow 82 to several thousands of tows 82 and, more narrowly, anywhere from 5 to 100 fiber tows 82 may be included in the fiber reinforced composite 80 of the elongated substrate 50. The fiber tow(s) 82 extend along a lengthwise extent 86 (FIGS. 8-9) of the elongated substrate 50 between the two ends 52, 54 of the clock spring 14, although, as discussed below, the fiber tow(s) 82 do not necessarily have to be aligned parallel with the lengthwise extent 86 of the elongated substrate 50 or with each other.

The fibers included in each of the individual fiber tows 82 can be composed of any of a wide variety of materials. For example, the fibers may be glass fibers, carbon fibers, natural fibers such as jute, flax, or cotton, ceramic fibers, polymer fibers such as aramid or polyester fibers, elastomeric fibers, metallic fibers such as steel, iron, copper, or aluminum, and shape memory alloy fibers such as nickel-titanium (NiTi) or copper-aluminum-nickel fibers. The resin matrix material 84 that encapsulates the plurality of fiber tows 82 may likewise be composed of any of a wide variety of materials. The resin matrix material 84 may, for example, be a cured thermoset polymer, a thermoplastic polymer, or an elastomer. If a cured thermoset polymer is desired, the resin matrix material 84 is preferably a cured resin selected from the following group: a polyimide resin, a phenolic resin, a polyester resin, an epoxy resin, a polyurethane resin, a silicone resin, a bismaleimide resin, and combinations thereof. If a thermoplastic polymer is desired, the resin matrix material 84 is preferably a polyamide such as nylon, a polyimide, polytetrafluoroethylene, high-density polyethylene, polyphenylene sulfide, polyphthalamide, polypropylene, nitrocellulose, polylactic acid, polyethylene, polycarbonate, polystyrene, nitrocellulose lacquer, or combinations thereof. If an elastomer is desired, the resin matrix material 84 is preferably silicone rubber, acrylonitrile-butadiene-styrene, polyvinylidene chloride, polyvinyl chloride, butyl rubber, a perfluoroelastomer, a fluoroelastomer, ethylene-vinyl acetate, styrene-butadiene rubber, or combinations thereof. The materials selected for the fiber tows 82 and the encapsulating resin matrix material 84 as well as the arrangement of the fiber tows 82 within resin matrix material 84 can be managed and implemented to tailor the characteristics of the clock spring 14 to fit a particular end-use application.

Each of the fiber tows 82 may be comprised of the same bundling of fibers or, alternatively, one or more of the fiber tows 82 may be comprised of a different bundling of fibers. For instance, as depicted in FIG. 5, a plurality of fiber tows 82 may include a combination of fiber tows that includes at least multiple first fiber tows 88 and multiple second fiber tows 90. The first fiber tows 88 may be grouped into spaced apart first and second layers 92, 94 and the second fiber tows 90 may be disposed as a layer 96 between the spaced apart first and second layers 92, 94. In one embodiment, the first fiber tows 88 may be glass fiber tows and the second fiber tows 90 may be carbon fiber tows, and vice versa. In another embodiment, the first fiber tows 88 may be metallic fiber tows and the second fiber tows 90 may be carbon or glass fiber tows, and vice versa. In still another embodiment, the first fiber tows 88 may be carbon or glass fiber tows and the second fiber tows 90 may be shape memory alloy fiber tows, and vice versa, as shape memory alloy fiber tows are expected to provide better damping capabilities in high-energy applications. Many different combinations of fiber tows are possible. And, of course, the combination of fiber tows may include more than just the first fiber tows 88 and the second fiber tows 90.

Additionally, an inner channel 98 may be defined within the fiber reinforced composite material 80 of the elongated substrate 50. For instance, as depicted in FIGS. 6-7, a plurality of fiber tows 82 may be circumferentially arranged about and thus surround a central inner channel 100 that extends along the lengthwise extent 86 of the elongated substrate 50. The plurality of fiber tows 82 that surround the inner channel 100 may include a plurality of the same fiber tows or a combination of at least multiple first fiber tows 88 and multiple second fiber tows 90. In FIG. 6, for example, the first fiber tows 88 may be grouped into spaced apart first and second layers 92, 94 located on opposite sides of the central inner channel 100, and the second fiber tows 90 may be disposed next to the central inner channel 100 between the spaced apart first and second layers 92, 94. The first and second fiber tows 88, 90 may be the same combinations of fiber tows discussed above in connection with FIG. 5. In another example, as shown in FIG. 7, multiple third fiber tows 102 may be disposed around the central inner channel 100 with the first fiber tows 88 and the second fiber tows 90 being alternately interjected between the third fiber tows 102. Here, the first fiber tows 88 may be glass fiber tows, the second fiber tows 90 may be carbon fiber tows, and the third fiber tows 102 may be shape memory alloy fiber tows, although other combinations are certainly possible.

The central inner channel 100 defined within the fiber reinforced composite material 80 of the elongated substrate 50 may be fully or partially filled with a gas and/or a liquid. A suitable gas that may occupy some or all of the central inner channel 100 may be air or an inert gas such as argon or nitrogen. A suitable liquid that may occupy some or all of the central inner channel 100 may be a heat-transfer fluid such as oil or water. The central inner channel 100 may be contained within the fiber reinforced composite material 80 to seal the gas and/or liquid therein. Or, in other variations, the center inner channel 100 may open at one or more locations so that the gas or liquid can be introduced into and removed from the channel 100. The opening(s) may be located at the two ends 52, 54 of the clock spring 14 or anywhere in between. The decision on whether to fill the central inner channel 100 with a gas, a liquid, or a combination of a gas and liquid may be based on whether the channel 100 is introduced into the fiber reinforced composite material 80 of the elongated substrate 50 for mass reduction purposes, in which case a gas may be more appropriate, or for purposes of being able to manage the temperature of the fiber reinforced composite material 80 depending on the environment, in which case a liquid may be more appropriate.

The inner channel 98 may be formed within the fiber reinforced composite material 80 of the elongated substrate 50 by incorporating a sacrificial fiber tow into the composite material 50 at the desired location of the inner channel 98 followed by removing the sacrificial fiber tow. The sacrificial fiber tow may be composed of low-melting point polymer fibers, dissolvable fibers, combustible fibers, depolymerizable fibers, vaporizable fibers, or any other type of fibers that can be selectively targeted and removed from the surrounding fiber reinforced composite material 80 through the application of heat, destructive chemical agents, etc. In this way, there is substantial design flexibility in the size, shape, and path of the inner channel 98. The decision surrounding the type of sacrificial fiber tow to be used to form the inner channel 98 depends on the type of fibers included in the other one or more fiber tows 82 and the composition of the resin matrix material 84. For example, if the reinforced composite material 80 includes glass and/or carbon fiber tows encapsulated by a cured epoxy or polyurethane resin, the sacrificial fiber tow may be formed of low-melting point polymer fibers so that the sacrificial tow can be easily melted away to provide the inner channel 98.

The spatial arrangement of the fiber tow(s) 82 may also be controlled to help achieve a given set of characteristics in the clock spring 14. As shown in FIG. 8, a plurality of fiber tows 82 (whether the same or comprised of a combination of multiple types of fiber tows) may be oriented parallel to one another along the lengthwise extent 86 of the elongated substrate 50. Such an orientation is satisfactory but not mandatory. Indeed, as shown in FIG. 9, each of the plurality of fiber tows 82 (again, whether the same or comprised of a combination of multiple types of fiber tows) may extend back-and-forth from one side of the fiber reinforced composite material 80 to the other side of the composite material 80 transverse to the lengthwise extent 86 of the elongated substrate 50 while progressing down the lengthwise extent 86 of the elongated substrate 50. As a result, the fiber tows 82 crisscross one another. Each of the spatial arrangements of the plurality of fiber tows 82 described in connection with FIG. 8 and FIG. 9 can accommodate an inner channel 98 defined within the fiber reinforced composite material 80 of the elongated substrate 50. Other arrangements of the one or more fiber tows 82 may also be implemented despite not being shown and described in detail here.

As alluded to above, the characteristics of the clock spring 14—most notably the mass and stiffness—can be tuned to meet certain desired specifications by managing the size, quantity, spatial arrangement, and composition of the fiber tow(s) 82 in conjunction with the composition of the resin matrix material 84. To provide the clock spring 14 with a higher strength and a lower elongation, for example, the resin matrix material 84 may be a cured epoxy resin or a cured polyurethane resin. Conversely, to provide the clock spring 14 with a lower strength and a higher elongation, the resin matrix material 84 may be nylon (or a relatively low strength cured epoxy or polyurethane). Moreover, the inclusion of the inner channel 98 within the fiber reinforced composite material 80 of the elongated substrate 50 can reduce the mass of the clock spring 14, especially if the channel 98 is filled with a gas. The inner channel 98 may also be used to exert some control over the elongation of the clock spring 14 during changes in the temperature of the surrounding environment. In that regard, a heat-temperature liquid may be introduced or even flow through the inner channel 98 to heat or cool the clock spring 14 which, in turn, can increase or decrease the elongation of the clock spring 14, respectively, at that time. Still further, if the fiber tows 82 are spatially arranged as shown in FIG. 9, a reduction in the stiffness of the clock spring 14 is attained relative to the spatial arrangement of the fiber tows 82 shown in FIG. 8 with everything else being equal.

Referring now to FIG. 3, the planetary damper 10 illustrated in FIGS. 1-2 is shown installed within a torque converter assembly 104 to damp torsional vibrations emanating from an upstream engine (not shown). The torque converter assembly 104 is housed within an automatic transmission casing and transfers torque between an engine crankshaft 106 and a transmission input shaft 108 that provides input power to downstream planetary gear train (not shown). The torque converter assembly 104 includes housing 110 that encloses a pump 112, a turbine 114, a stator 116, a torque converter clutch 118, and the planetary damper 10. The housing 110 includes a front cover 120 and a rear cover 122 that are secured together. The pump 112 is fixed to an inside of the rear cover 122 and includes a plurality of circumferentially-spaced curved vanes 124 contoured to centrifugally displace hydraulic fluid when rotated. The front cover 120 of the housing 110 is preferably flexibly fastened to an engine flywheel 126 through a flex plate 128 by suitable fasteners. The engine crankshaft 106 is operably engaged to the engine flywheel 124 and, thus, rotationally drives the entire housing 110 of the torque converter assembly 104 as well as the pump 112.

The turbine 114 is mounted to the transmission input shaft 108. In particular, as shown here in FIG. 3, a hub 130 of the turbine 114 is splined to the input transmission shaft 108 by a spline gear 132, which refers to meshed male and female spline gear teeth. The turbine 114 includes circumferentially-spaced curved vanes 134 that oppose the pump 112. The vanes 134 of the turbine 114 are contoured to inwardly reroute the centrifugally displaced hydraulic fluid of the pump 112, which establishes a fluid coupling between the pump 112 and the turbine 114, meaning that the momentum of the displaced fluid caused by rotation of the pump 112 propels rotation of the turbine 114 by way of a hydrodynamic circuit. The stator 116 is positioned between the pump 112 and the turbine 114 and is connected to a fixed transmission shaft 136 via an overrunning clutch 138 that prevents the stator 116 from counterrotating relative to the pump 112 and the turbine 114. The stator 116 includes vanes that redirect hydraulic fluid returning from the turbine 114 so that the fluid re-enters the pump 112 in the same direction as the pump 112 is rotating to complete the hydrodynamic circuit. During periods of high slippage between the pump 112 and the turbine 114, the re-routing of the hydraulic fluid by the stator 116 has the added function of multiplying torque.

The planetary damper 10 is mounted to the transmission input shaft 108 along with the turbine 114. In this embodiment, as shown, the sun gear 16 is splined to the input transmission shaft 108 by a spline gear 140, which includes the internal gear teeth 26 of the sun gear 16 mated with external gear teeth on the shaft 108, upstream from the turbine 130 hub, although in other design variations the sun gear 16 may be splined to an axially-extended portion of the turbine hub 130 that extends between the transmission shaft 108 and the sun gear 16 or may be riveted to the axially-extended hub portion thereby removing the need for the internal gear teeth 26 of the sun gear 16. The planet gear assembly 18 and the ring gear 20 are connected by the clock spring 14 but can experience relative angular movement due to the compression and relaxation of the clock spring 14. When the pump 112 is propelling the turbine 114 to drive the transmission input shaft 108 through the fluid coupling established between the pump 112 and the turbine 114, the sun gear 16 co-rotates with the transmission input shaft 108 while the planet gear assembly 18 and the ring gear 20 freewheel about the transmission input shaft 108 since neither of those gear components 18, 20 are transferring torque into or out of the planetary damper 10 at that time.

The torque converter clutch (TCC) 118 is positioned between the front cover 120 of the torque converter housing 110 and the planetary damper 10, and is engageable to couple the planetary damper 10 to the front cover 120 of the torque converter housing 110 to transfer torque mechanically from the engine crankshaft 106 to the transmission input shaft 108 through the planetary damper 10. To that end, the TCC 118 includes an axially-actuatable piston or apply plate 142 and a friction plate 144 interposed between the piston plate 142 and the front cover 120 of the torque converter housing 110. The friction plate 144 has a protruding annular rim portion 146 that defines spaced apart notches 148. Each of these notches 148 receives one of a plurality of corresponding radially-outwardly extending tabs 150 positioned circumferentially around the connection plate 64 of the planetary damper 10, which is located on an opposite side of the piston plate 142, to interlock the friction plate 144 and the connection plate 64 together so that the two plates 144, 64 co-rotate with one another. The piston plate 142 is engageable to selectively press the intervening friction plate 144 against the front cover 120 of the torque converter housing 110. This in turn locks the ring gear 20 of the planetary damper 10 to the torque converter housing 110 and results in the ring gear 20 being driven by the engine crankshaft 106 and serving as the input to the planetary damper 10.

The planetary damper 10 damps torsional vibrations emanating from the engine whenever the TCC 118 is engaged or closed. The TCC 118 is typically engaged after the pump 112 and the turbine 114 have begun rotating at or close to the same speed in an effort to improve fuel economy. When the TCC 118 is engaged, the piston plate 142 is actuated to engage and press the friction plate 144 against the front cover 120 of the torque converter housing 110 to lock the ring gear 20 of the planetary damper 10 to the front cover 120 and, consequently, break the fluid coupling between the pump 112 and the turbine 114. The ring gear 20 drives rotation of the planet gear assembly 18 by way of the clock spring 14 while, at the same time, the clock spring 14 allows for restrained relative angular movement between the ring gear 20 and the planet gear assembly 18. This restrained relative angular movement absorbs torsional vibrations and isolates the sun gear 16 from such oscillations. The rotation of the ring gear 20 and the planet gear assembly 18 ultimately rotates the sun gear 16, which, in turn, drives the transmission input shaft 108 and serves as the output of the planetary damper 10.

As mentioned above, the specific design of the planetary damper 10 shown in FIGS. 1-3 is merely representative and, accordingly, variations to that design are possible. One such design variation is shown in FIG. 4. The planetary damper shown here, which is identified by reference numeral 10′, is similar in many respects to the planetary damper 10 shown in FIGS. 1-3, and only the differences between the damper embodiments will be described in further detail below. In describing and identifying the features of the planetary damper 10′ depicted in FIG. 4, elements or features of the disclosed damper 10′ that correspond to the same or similar elements or features of the damper 10 depicted in FIGS. 1-3 are identified by like reference numerals. The previous description of those corresponding elements or features is intended to apply to the embodiment of FIG. 4 along with any further description provided hereinafter. To that end, the major difference between the planetary damper 10′ shown in FIG. 4 and planetary damper 10 shown in FIGS. 1-3 and the is the way in which the clock spring 14′ is connected to the planetary gear set 12′.

The clock spring 14′ of the planetary damper 10′ shown in FIG. 1 is connected to the ring gear 20′ and the planet gear assembly 18′—much like the previous embodiment of planetary damper 10—with the innermost radial rung 56′ being connected to the ring gear 20′ and the outermost radial rung 58′ being connected to the planet gear assembly 18′. But in this instance, the connection plate 64′ may integrally extend from or be separately affixed by welding and/or mechanically interlocking to the planet carrier 32′, preferably by way of the free ends of the pinion shafts 40′ that extend through the pinion gears 30′, and the support plate 66′ may be axially spaced from yet integrally formed with or bolted to the ring gear 20′. The notches 148′ defined in the protruding annular rim portion 146′ of the friction plate 144′ receives the corresponding radially-outwardly extending tabs 150′ positioned circumferentially around the connection plate 64′, as before, to interlock the friction plate 144′ and the connection plate 64′ together so that the two plates 144′, 64 co-rotate with one another.

Relative to the planetary damper 10 depicted in FIG. 3, the planetary damper 10′ in this embodiment switches the gear component 18′, 20′ that is associated with the input (engine crankshaft 106′) while keeping the output (transmission input shaft 108′) of the damper 10′ the same. Here, when the TCC 118′ is engaged and the piston plate 142′ engages and presses the intervening friction plate 144′ against the front cover 120′ of the torque converter housing 110′, the planet gear assembly 18′ is locked to the torque converter housing 110′ and, thus, is driven by the engine crankshaft 106′. The planet gear assembly 18′ drives rotation of the ring gear 20′ by way of the clock spring 14 while, at the same time, the clock spring 14′ allows for restrained relative angular movement between the planet gear assembly 18′ and the ring gear 20′. This restrained relative angular movement absorbs torsional vibrations and isolates the sun gear 16′ from such oscillations. The rotation of the planet gear assembly 18′ and the ring gear 20′ ultimately rotates the sun gear 16′, which, in turn, drives the transmission input shaft 108′ and serves as the output of the planetary damper 10′.

In another design variation, the planetary damper may include multiple clock springs as shown, for example, in FIG. 10 isolated from the planetary gear set. There, one additional clock spring 14″ is shown along with the clock spring 14 described above, and it is to be understood that further additional clock springs may be present despite not being expressly illustrated. Typically, anywhere from one to four clock springs may be present in total in the planetary damper. The additional clock spring 14″ as well as any others that may be present may be constructed in the same manner and have the same functionalities as the clock spring 14 described above, and thus the description of the clock spring 14 above applies equally here. In the embodiment shown in FIG. 10, the clock springs 14, 14″ are angularly offset and interleaved such that the planar connection ends 70, 70″ of the innermost radial rungs 56, 56″ are connected to opposed portions of their respective connection or support plate (not shown) and, likewise, the planar connection ends 74, 74″ of the outermost radial rungs 58, 58″ are connected to opposed portions of their respective connection or support plate (not shown), by fasteners or some other joining approach. The various rungs 56, 58, 62, 56″, 58″, 62″ of the interleaved clock springs 14, 14″ also alternate along a direction extending radially outwardly from the planar connection end 70, 70″ of the innermost radial rung 56, 56″ of one of the clock springs 14, 14″ to the planar connection end 74, 74″ of the outermost radial rung 58, 58″ of the other clock spring 14, 14″. The use of multiple clock springs 14, 14″ provides further design flexibility for the planetary damper and allows for spring characteristics and damping capabilities to be achieved that might be difficult to attain with only a single clock spring.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

What is claimed is:

1. A planetary damper comprising:
a planetary gear set having multiple rotatable gear components, the gear components comprising a sun gear, a planet gear assembly having a plurality of pinion gears rotatably mounted on a planet carrier, and a ring gear, each of the plurality of pinion gears having external teeth that mesh with external teeth of the sun gear, and the ring gear having internal teeth that mesh with the external teeth of each of the plurality of pinion gears; and
at least one clock spring that comprises an elongated substrate wound circumferentially around the planetary gear set, the clock spring having an innermost radial rung and an outermost radial rung spaced radially outwardly from the innermost radial rung, the innermost radial rung of the clock spring being connected to one of the gear components of the planetary gear set and the outermost radial rung of the clock spring being connected to another of the gear components of the planetary gear set such that the clock spring damps vibrations when the gear components to which the clock spring is connected experience relative angular movement.

2. The planetary damper set forth in claim 1, wherein the clock spring includes one or more intervening radial rungs between the innermost radial rung and the outermost radial rung.

3. The planetary damper set forth in claim 1, wherein the elongated substrate of the clock spring is composed of a metal or alloy.

4. The planetary damper set forth in claim 1, wherein the elongated substrate of the clock spring includes a fiber reinforced composite, the fiber reinforced composite comprising one or more fiber tows encapsulated by a resin matrix material.

5. The planetary damper set forth in claim 4, wherein each of the one or more fiber tows comprises a bundling of fibers comprising glass fibers, carbon fibers, natural fibers, polymer fibers, elastomeric fibers, metallic fibers, or shape memory alloy fibers.

6. The planetary damper set forth in claim 4, wherein the resin matrix material comprises a cured epoxy resin, a cured polyurethane resin, or nylon.

7. The planetary damper set forth in claim 4, wherein the fiber reinforced composite includes a plurality of fiber tows, and wherein each of the plurality of fiber tows includes at least multiple first fiber tows and multiple second fiber tows, the first fiber tows and the second fiber tows being comprised of a different bundling of fibers.

8. The planetary damper set forth in claim 4, wherein an inner channel is defined within the fiber reinforced composite material of the elongated substrate.

9. The planetary damper set forth in claim 8, wherein the inner channel is a central inner channel that extends along a lengthwise extent of the elongated substrate and is surrounded circumferentially by the one or more fiber tows.

10. A torque converter assembly comprising:
a torque converter comprising a pump and a turbine enclosed within a torque converter housing, the pump being secured to a front cover of the torque converter housing, which is rotationally driven by an engine crankshaft, and the turbine being mounted on a transmission input shaft;
a planetary damper mounted on the transmission input shaft, the planetary damper comprising:
a planetary gear set having multiple rotatable gear components, the gear components comprising a sun gear, a planet gear assembly having a plurality of pinion gears rotatably mounted on a planet carrier, and a ring gear, each of the plurality of pinion gears having external teeth that mesh with external teeth of the sun gear, and the ring gear having internal teeth that mesh with the external teeth of each of the plurality of pinion gears; and
at least one clock spring that comprises an elongated substrate wound circumferentially around the planetary gear set, the clock spring having an innermost radial rung and an outermost radial rung spaced radially outwardly from the innermost radial rung, the innermost radial rung of the clock spring being connected to one of the gear components of the planetary gear set and the outermost radial rung of the clock spring being connected to another of the gear components of the planetary gear set; and
a torque converter clutch engageable to couple the planetary damper to the front cover of the torque converter housing to transfer torque mechanically from the engine crankshaft to the transmission input shaft through the planetary damper, the planetary damper damping the transmission of torsional vibrations from the engine crankshaft to the input transmission shaft when the torque converter clutch is engaged, and wherein only one of the gear components to which the clock spring is attached is driven by the engine crankshaft or drives the transmission input shaft when the torque converter clutch is engaged.

11. The torque converter assembly set forth in claim 10, wherein the innermost radial rung of the clock spring is connected to the one of the ring gear or the planet gear assembly of the planetary gear set, and the outermost radial rung is connected to the other of the ring gear or the planet gear assembly.

12. The torque converter assembly set forth in claim 10, wherein the elongated substrate of the clock spring includes a fiber reinforced composite, the fiber reinforced composite comprising one or more fiber tows encapsulated by a resin matrix material.

13. The torque converter assembly set forth in claim 12, wherein the fiber reinforced composite comprises a plurality of fiber tows, each of the plurality of fiber tows comprising a bundling of fibers, and wherein the plurality of fiber tows includes at least multiple first fiber tows and multiple second fiber tows, the first fiber tows and the second fiber tows being comprised of a different bundling of fibers.

14. The torque converter assembly set forth in claim 12, wherein the plurality of fiber tows is circumferentially arranged about and surround a central inner channel defined within and extending along a lengthwise extent of the fiber reinforced composite.

15. The torque converter assembly set forth in claim 10, wherein the torque converter clutch includes a piston plate that is engageable to press an intervening friction plate against the front cover of the torque converter housing.

16. The torque converter assembly set forth in claim 15, wherein the planetary damper includes a connection plate attached to the gear component to which the innermost radial rung of the clock spring is connected or to the gear component to which the outermost radial rung of the clock spring is connected, the connection plate being further attached to the friction plate and being located on an opposite side of the piston plate from the friction plate.

17. A torque converter assembly comprising:
a torque converter comprising a pump and a turbine enclosed within a torque converter housing, the pump being secured to a front cover of the torque converter housing, which is rotationally driven by an engine crankshaft, and the turbine being mounted on a transmission input shaft;
a planetary damper mounted on the transmission input shaft, the planetary damper comprising:
a planetary gear set having multiple rotatable gear components, the gear components comprising a sun gear, a planet gear assembly having a plurality of pinion gears rotatably mounted on a planet carrier, and a ring gear, each of the plurality of pinion gears having external teeth that mesh with external teeth of the sun gear, and the ring gear having internal teeth that mesh with the external teeth of each of the plurality of pinion gears; and
at least one clock spring that comprises an elongated substrate wound circumferentially around the planetary gear set, the clock spring having an innermost radial rung and an outermost radial rung spaced radially outwardly from the innermost radial rung, the innermost radial rung and the outermost radial rung of the clock spring being separately connected to any two the rotatable gear components of the planetary gear set; and
a torque converter clutch engageable to couple the planetary damper to the front cover of the torque converter housing to transfer torque mechanically from the engine crankshaft to the transmission input shaft through the planetary damper, wherein one of the gear components to which the clock spring is attached is driven by the engine crankshaft via the torque converter housing or drives the transmission input shaft, and wherein the other gear component to which the clock spring is attached is neither driven by the engine crankshaft nor drives the transmission input shaft, such that the planetary damper damps the transmission of torsional vibrations from the engine crankshaft to the input transmission shaft when the torque converter clutch is engaged.

18. The torque converter assembly set forth in claim 17, wherein the elongated substrate of the clock spring includes a fiber reinforced composite, the fiber reinforced composite comprising one or more fiber tows encapsulated by a resin matrix material.

19. The torque converter assembly set forth in claim 17, wherein the fiber reinforced composite comprises a plurality of fiber tows, and wherein the plurality of fiber tows is circumferentially arranged about and surround a central inner channel defined within and extending along a lengthwise extent of the fiber reinforced composite, the central inner channel being filled with a gas and/or a liquid.

20. The torque converter assembly set forth in claim 17, wherein the torque converter clutch includes a piston plate that is engageable to press an intervening friction plate against the front cover of the torque converter housing, wherein the planetary damper includes a connection plate attached to the ring gear or the planet gear assembly and being located on an opposite side of the piston plate from the friction plate, the connection plate being further attached to the friction plate.
